(19) United States
(12) Patent Application Publication
(10) Pub. No.: US 2004/0225527 A1
(43) Pub. Date: Nov. 11, 2004

(54) Prescription fulfillment system and method

(76) Inventor: Siegfried K. Holz, Lakeland, FL (US)

Correspondence Address: Charles J. Prescott, Charles J. Prescott, P.A., Suite 115, 2033 Wood Street, Sarasota, FL, 34237-7926, US

(21) Appl. No.: 10/008,488

(22) Filed: Nov. 5, 2001

(51) Int. Cl. G06F 17/60

(52) U.S. Cl. 705/2; 455/556.2

(57) ABSTRACT

A system for providing and updating a portable patient memory card and for prescription fulfillment. The system includes a modifiable personal memory card (PMC) for the patient which includes the patient's personal information, physician information, pharmacy information, medical history, insurer information and authentification code. A PMC reader/writer presents the stored memory to a personal digital assistant (PDA) during a medical examination by the physician. The physician may then update the stored memory to include new prescriptions and additional medical history. Another PMC reader/writer in the physician's office electronically transfers the updated stored memory to a central host server. The host server receives and stores the updated stored memory and electronically transmits a prescription fulfillment request for new prescriptions to a selected pharmacy and electronically transmits a confirmation back to the office computer when fulfilled. Insurer information may also be electronically transferred from the host server to a designated insurer.

### BACKGROUND OF THE INVENTION

1. Scope of Invention

This invention relates generally to the field of medicine and more particularly to systems and methods for providing portable patient medical history and prescription fulfillments in conjunction with medical examinations by physicians.

2. Prior Art

Although the record keeping functions associated with routine or emergency office visits with a physician have greatly improved, nonetheless the inconvenience of the lack of centrally located portable medical histories for patients and the easy and convenient prescription fulfillment for prescriptions ordered by a physician at the time of physical examination of a patient are still somewhat archaic and cumbersome.

U.S. Pat. No. 4,695,954, invented by Rose et al., teaches an apparatus and method for dispensing medications utilizing a portable memory device used to store data representing prescription information. A container having a plurality of individual compartments is filled with medication at the pharmacy in accordance with the prescription information provided on the portable memory device.

An automatic system for printing prescription forms is disclosed in U.S. Pat. No. 5,528,021 invented by Lassus et al. This invention uses a chip (personal memory) card (PMC) reader with a microprocessor and a printer and is aimed at simplifying the operations of transcribing the information on the prescription and limiting the risks of prescription fraud.

Thornton, in U.S. Pat. No. 5,628,530, discloses a method and system for tracking prescribed starter drug samples dispensed to patients. The system employs the use of a smart card which has been encoded with the prescription information and is decoded at the pharmacy via a conventional card reader and input into the pharmacy computer for providing tracking information for the dispensed starter drug samples.

U.S. Pat. No. 5,737,539 to Edelson et al. teaches a prescription creation system permitting creation of a single prescription to be automatically divided for fulfillment of one portion quickly and another portion by remote mail order. This system further has the ability to access remote source databases for presentation to the prescriber of relevant, authorized and drug formulary and patient history.

A prescription management system is disclosed in U.S. Pat. No. 5,845,255 invented by Mayaud. This invention teaches use of a personal digital assistant (PDA) for use by a physician to input prescribed treatment and patient records with privacy controls and online access to comprehensive drug information. The preferred embodiment relates to a computer-implemented prescription system to assist physicians in prescribing and reviewing drugs.

Sattizahn et al discloses in U.S. Pat. No. 5,884,273 a hand-held microcomputer with an attached printer that receives input from a physician and prints out a legible prescription slip. The prescription slip contains relevant information for the patient and pharmacists.

U.S. Pat. No. 5,991,731 relates to clinical studies and teaches a method and system for interactive prescription and distribution of prescriptions in conducting those studies. The system communicates data over the Internet to determine patient eligibility, randomization and initial prescriptions which can be adjusted by the physician online. The prescription is then printed out for signature and send electronically to a distribution center.

An electronic pocket pillbox and prescription writing apparatus is taught in U.S. Pat. No. 6,032,085 issued to Laurent et al. A physician prepares a prescription utilizing a computer which loads the prescription file into the memory of a smart card which is put into the pillbox to supply signals to the pillbox advising the user to take the medication.

U.S. Pat. No. 6,067,524 discloses a system for automatically generating advisory information for distribution to pharmacy patients. The system generates advisory messages to patents including patient-specific information to a data record which is transmitted between a third party computer and a pharmacy computer during a pharmacy transaction.

A computer-based pharmaceutical practice management system and healthcare management system for use by a pharmacy is disclosed in U.S. Pat. No. 6,112,182 issued to Akers et al. Health conditions of a patent, drugs taken by the patient and other information gathered by the pharmacist will automatically initiate related actions handled by processes of the healthcare management system.

Barry et al., in U.S. Pat. No. 6,188,988 discloses a system, method and computer program for treatment for known diseases. The method comprises inputting patient information onto a computer, generating in the computer a listing of treatment regimens for the patient and generating advisory information for one or more treatment regimens.

An electronic clinical recording system is shown in U.S. Pat. No. 6,272,470 issued To Teshima. The system comprises a portable storage medium for storing the patient's record and an element for reading the patient's record, the major object being to provide an electronic clinical recording system for a hospital information system enabling the sharing of medical information at low cost without concern of type of equipment.

In U.S. Pat. No. 6,281,798, Laurent et al. teaches a multi-compartment electronic pocket pillbox with a microprocessor having memory loaded with prescription data. This pillbox further includes a control circuit for display, circuitry for loading into the memory data contained in a detachable data medium and detectors for ascertaining from which compartment the pill was withdrawn.

### BRIEF SUMMARY OF THE INVENTION

This invention is directed to a system and method for preparing and fulfilling a medication prescription written by a physician at the time of conducting a physical examination of a patient. The system includes a personal memory card (PMC) for the benefit of, and carried by, the patient which is configured to include a modifiable stored memory including the patient's personal information, consulting physician information, accessible pharmacy information, medical history, insurer information and authentification code. A PMC reader/writer receives the PMC and viewably presents the stored memory on a personal digital assistant (PDA) in conjunction with the examination of the patient by the physician. After the examination, stored memory is modifiable by the physician via the PDA to include any new medication prescriptions required and additional medical history to form an updated stored memory. Another PMC reader/writer connected to an office computer of the physician is configured to receive and electronically transfer the updated stored memory to a remotely located central host server. The host server is configured to receive and store the updated stored memory and to electronically transmit a prescription fulfillment request for any new prescriptions contained within the updated stored memory to a selected one of the accessible pharmacies identified in the stored memory and to electronically transmit a confirmation back to the office computer advising that any new prescriptions are fulfilled. Appropriate insurer information may also be electronically transferred from the host server to a designated insurer.

It is therefore an object of this invention to provide a system and method for providing a portable modifiable memory card for patients which is utilized by a physician during an office visit to amplify or modify prescriptions for medicine, to effect prescription fulfillment and to establish and update stored medical history of each patient both on the memory card and in the computer system of a host server.

It is another object of this invention to provide a system and method for physical examination, medical history update and prescription fulfillment all of which are accomplished while the patient is at the office of the physician.

In accordance with these and other objects which will become apparent hereinafter, the instant invention will now be described with reference to the accompanying drawings.

### BRIEF DESCRIPTION OF THE DRAWINGS

FIG. 1 is a schematic view of one aspect of the invention associated with the physical examination by a physician.

FIG. 2 is a schematic view of another portion of the invention including the physician's office computer, the central host server, third party pharmacies and insurer's computers.

FIG. 3 is a block flow diagram of the invention with respect to the patient physical examination by a physician, the authorization of new prescriptions and updating medical history.

FIG. 4 is a flow diagram of the invention related to the transferring of updated stored medical history and new prescriptions from the office of the examining physician to a central host server and thereafter to a selected pharmacy for prescription fulfillment.

### DETAILED DESCRIPTION OF THE INVENTION

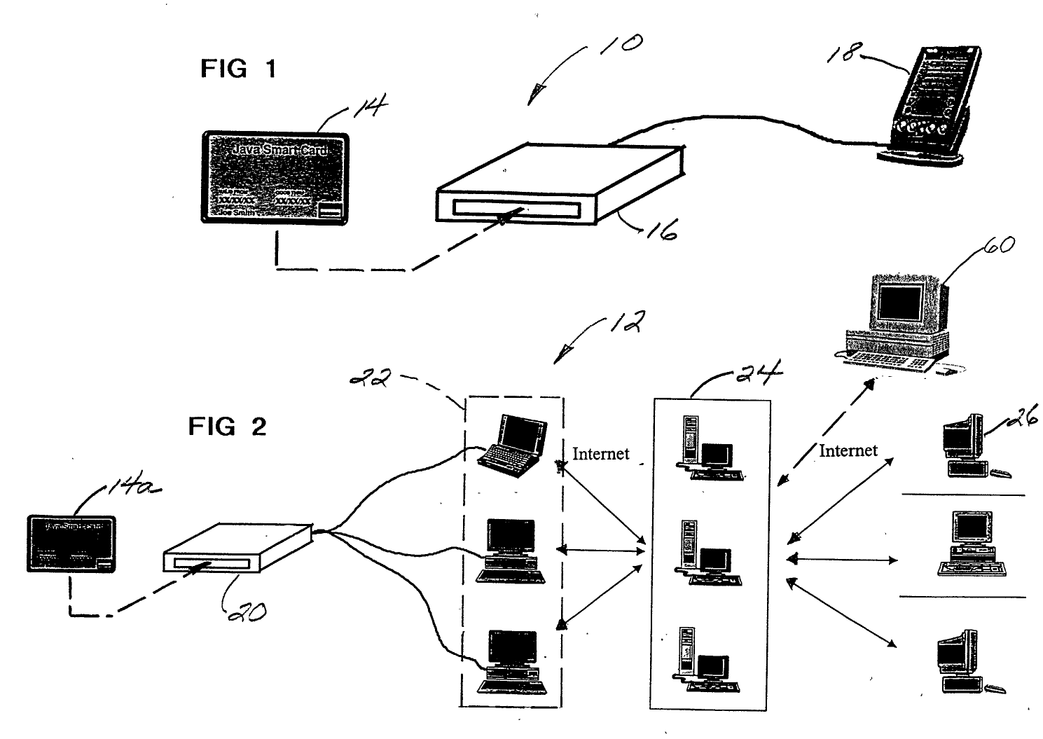

Referring now to the drawings and particularly to FIG. 1, a portion of the system is there shown generally at numeral 10 and includes a personal memory card (PMC) 14 known as a java card or a SMART CARD having a programmable memory chip embedded therein. The PMC 14 is initially issued to a patient and is programmed to include stored memory related to the name, address and other personal information of the patient, information regarding physicians that have attended to the patient, including the name of each physician, the area of expertise, location, phone number, etc. This stored memory also includes information regarding pharmacies to which the patient has access including the name, location, phone number, etc. of each designated pharmacy. The patient's medical history, past medical problems, known allergies and reactions and current medication are further included. Finally, an authentification code is added to the stored memory which serves to insure that the person bearing and presenting the PMC is indeed the proper patient identified in the stored memory of that PMC.

Still referring to FIG. 1, when the patient undergoes a physical examination by a physician, the PMC 14 is presented at the time of the commencement of the examination and the physician then inserts the PMC 14 into a PMC reader/writer 16 which reads and conveys the stored memory to a personal digital assistant PDA) 18 such as a PALM PILOT and the like. The physician may then review the entire medical history of the patient before beginning the physical examination. At the end of the examination, the physician will typically then, using the PDA 18, modify the stored memory by entering his diagnosis of new medical conditions and by writing one or more new prescription authorizations into the updated stored memory. When this updating is completed by the physician, the PMC 14 is removed from the PMC reader/writer 16 and returned to the patient.

Referring now to FIG. 2, the patient then moves to the central office area of the physician's facility and presents the updated PMC 14a to personnel in the office. The updated PMC 14a is inserted into another PMC reader/writer 20, the updated stored memory then transferred to one of the office computers 22. Thereafter, while the patient waits, the updated stored memory is transmitted via Internet connection to a central host server 24. This host server 24 includes a bank of appropriate computer equipment to receive and store the updated stored memory and to discern that new prescriptions and other information have been entered into the updated stored memory. The host server 24 then seeks out by Internet connection one of the pharmacies designated in the updated stored memory with which to place a prescription fulfillment request. This is done by the Internet to locate the first pharmacy 26 from the stored memory listing of pharmacies convenient to the patient which is recognized as being capable of prescription fulfillment by return confirmation to the host server 24.

When the host server 24 receives prescription fulfillment request confirmation, a fulfillment confirmation is transmitted by the Internet back to the office computer 22. When that confirmation is received, the patient's PMC is returned to him or her to complete the office visit.

As an additional function of the host server 24, electronic communication by the Internet may also be facilitated to transmit billing information concerning the physical examination and new prescription requests to an insurer computer 60. This information transfer to the insurance computer 60 may be utilized to expedite the billing and payment of the charges for the physical examination and to advise the insurance computer facility 60 that the new prescription has been authorized. Ideally, by including information transfer between the host server 24 and the insurance computer 60, expedited payment authorization for these medical services and prescriptions will be substantially expedited and improved upon from an efficiency standpoint.

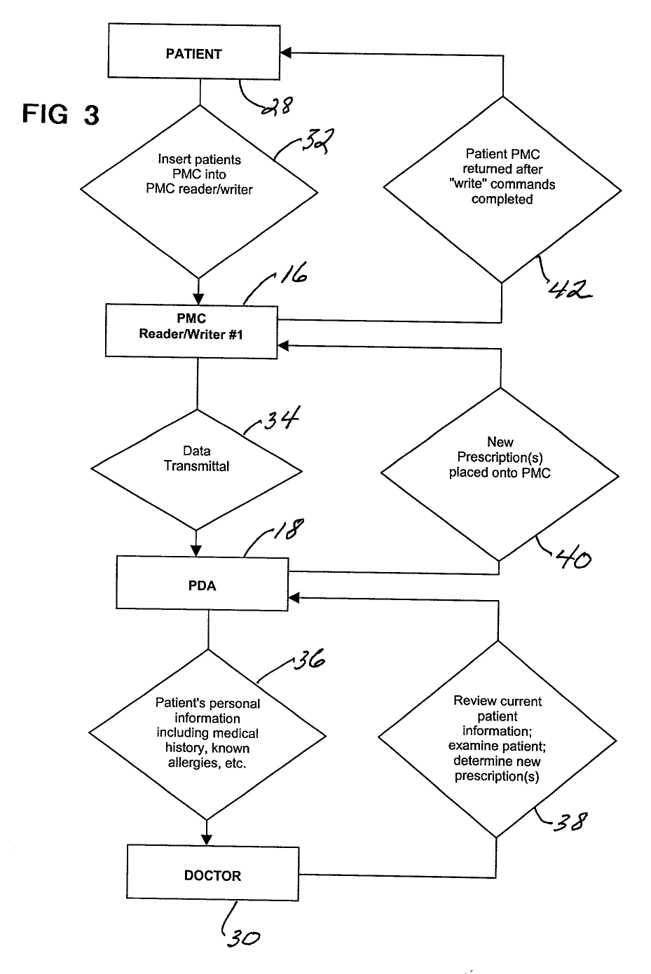

A flow diagram with respect to the physical examination proceeding between the physician 30 and the patient 28 is depicted in block form in FIG. 3. The patient provides his PMC to the physician at 32 who then inserts the PMC into the PMC reader 16. Data is transmitted at 34 to the doctor's PDA 18 whereupon he reviews the current stored memory information at 36 and then commences the physical examination of the patient 28. After the physical examination is completed and any new prescriptions are determined to be necessary at 38, the physician 30 then enters these new prescriptions and updated medical history into the PDA 18. These updates are then transferred at 40 into the permanent stored memory of the PMC by the PMC reader/writer 16. After the stored memory has been updated to establish an updated stored memory at 42, the PMC is returned to the patient.

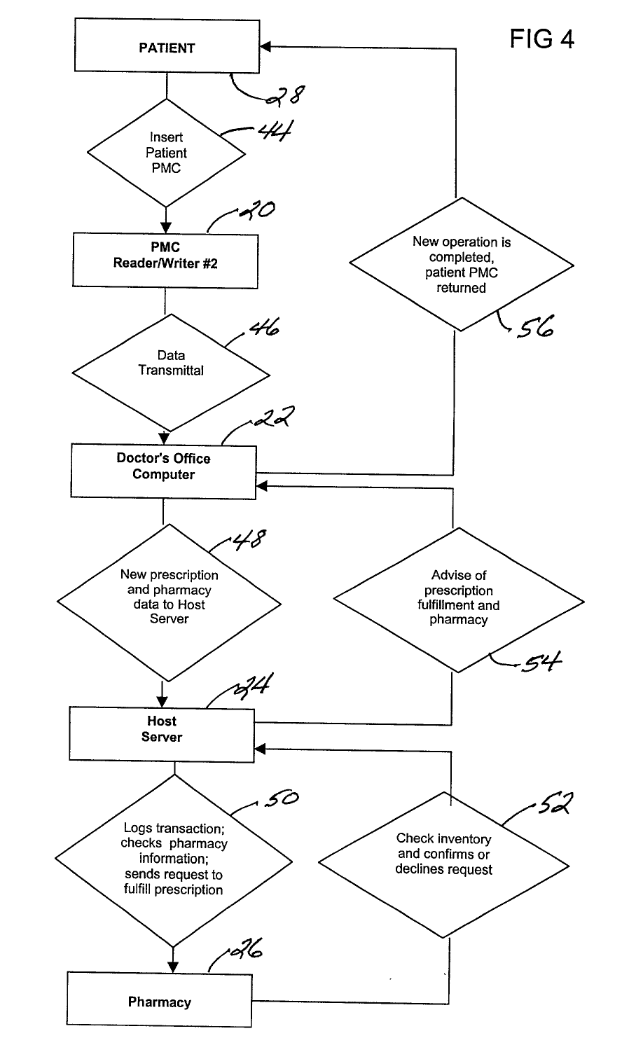

Referring lastly to FIG. 4, once the patient 28 has completed the physical examination and updated stored memory has been entered onto his or her PMC, the patent then moves into the main office area where the physician is located and personnel will again accept his PMC and insert it at 44 into a second PMC reader/writer 20. The updated stored memory will be transmitted at 46 into the office computer 22. Internet connection is then established with the host server 24 and the new prescription and pharmacy data and updated medical history will be transmitted electronically at 48 into the host server 24.

The host server 24 will then establish Internet connection with a preselected pharmacy 26 from the updated stored memory on the PMC at 50. The pharmacy 26 will then check and confirm prescription inventory at 52 and will either confirm the fulfillment request or decline the request due to unavailability of the medication ordered. Once a pharmacy 26 has confirmed fulfillment, the host server 24 will advise of prescription fulfillment and the details and location of the pharmacy at 54 to the doctor's office computer 22. As soon as the doctor's office computer 22 receives prescription fulfillment confirmation, the PMC will be returned to the patient 28 at 56 to complete the patient's office visit.

While the instant invention has been shown and described herein in what are conceived to be the most practical and preferred embodiments, it is recognized that departures may be made therefrom within the scope of the invention, which is therefore not to be limited to the details disclosed herein, but is to be afforded the full scope of the claims so as to embrace any and all equivalent apparatus and articles.

What is claimed is:

1. A system for preparing and fulfilling a patient's prescription written by a physician for medication comprising:
a personal memory card (PMC) for the benefit of, and carried by the patient, said PMC configured to include a modifiable stored memory including the patient's personal information, consulting physician information, accessible pharmacy information, medical history and authentification code;
a first PMC reader/writer for receiving and viewably presenting said stored memory on a personal digital assistant (PDA) in conjunction with a physical examination of the patient by the physician, said stored memory being modifiable by the physician via said PDA to include any new medication prescriptions and additional medical history to form an updated stored memory;
a second PMC reader/writer connected to an office computer of the physician configured to receive and electronically transfer said updated stored memory to a remotely located central host server;
said host server configured to store said updated stored memory and to electronically transmit a prescription fulfillment request for any new prescriptions contained within said updated stored memory to a selected one of the accessible pharmacies and to electronically transmit a confirmation back to said office computer advising that the new prescriptions are fulfilled.

2. A method of preparing and fulfilling a medication prescription written by a physician for a patient at the time of physical examination comprising the steps of:
A. providing a personal memory card (PMC) established for the benefit of, and carried by the patient, said PMC configured to include a stored memory including the patient's personal information, consulting physician information, accessible pharmacy information, medical history, insurer information and an authentification code;
B. reading said stored memory into a first PMC reader/writer from said PMC and viewably presenting said stored memory on a personal digital assistant (PDA) in conjunction with a physical examination of the patient by the physician;
C. modifying said stored memory of said PMC by the physician via entry on said PDA to include new medication prescriptions and additional medical history to form an updated stored memory;
D. reading said updated stored memory of said PMC via a second PMC reader/writer into to an office computer of the physician, said office computer configured to electronically transfer said updated stored memory to a remotely located central host server;
E. transferring said updated stored memory to the host server by the Internet;
F. transmitting a prescription fulfillment request electronically by said host server for new prescriptions contained within said updated stored memory to one of the accessible pharmacies, said host server configured to store said updated stored memory and for electronically transmitting said request;
G. transmitting a confirmation electronically from one of the pharmacies selected in step F back to said office computer advising that any new prescriptions are fulfilled.

3. A system for preparing and fulfilling a patient's prescription written by a physician for medication comprising:
a personal memory card (PMC) for the benefit of, and carried by the patient, said PMC configured to include a stored memory including the patient's personal information, consulting physician information, accessible pharmacy information, medical history and authentification code;
a first PMC reader/writer for receiving and viewably presenting said stored memory on a personal digital assistant (PDA) in conjunction with an examination of the patient by the physician, said stored memory being modified by the physician via corresponding entry on said PDA to include new medication prescriptions and additional medical history to form an updated stored memory;
a second PMC reader/writer connected to the physician's office computer configured to receive said updated stored memory read and received from said PMC and to transfer said updated stored memory to a remotely located central host server by the internet;
said host server configured to receive and store said updated stored memory and to their select one of the accessible pharmacies and to then transmit a prescription fulfillment request for any new prescriptions contained within said updated stored memory to the selected accessible pharmacy and to then transmit a confirmation back to said office computer advising when the new prescriptions are fulfilled.

4. The system of claim 1 wherein:
said stored memory of said PMC is also configured to include insurer information;
said host server is also configured to electronically transfer insurance information of said updated stored memory to an insurer designated in said updated stored memory.

5. The method of claim 2, further comprising the steps of:
H. electronically transmitting appropriate insurer information by said host server corresponding to the examination and new prescriptions.

6. The system of claim 3 wherein:
said stored memory of said PMC is also configured to include insurer information;
said host server is also configured to electronically transfer insurance information of said updated stored memory to an insurer designated in said updated stored memory.
